(19) United States
(12) Patent Application Publication
(10) Pub. No.: US 2025/0150817 A1
(43) Pub. Date: May 8, 2025

(54) Authentication Mechanism for Access to an Edge Data Network Based on TLS-PSK

(71) Applicant: Apple Inc., CUPERTINO, CA (US)

(72) Inventors: Shu GUO, Beijing (CN); Dawei ZHANG, Saratoga, CA (US); Haijing HU, Los Gatos, CA (US); Huarui LIANG, Beijing (CN)

(21) Appl. No.: 18/833,666

(22) PCT Filed: Jan. 28, 2022
(86) PCT No.: PCT/CN2022/074625

§ 371 Date: Jul. 26, 2024

(51) Int. Cl. H04W 12/0431; H04W 12/041; H04W 12/102

(52) U.S. Cl. CPC H04W 12/0431; H04W 12/041; H04W 12/102

(57) ABSTRACT

A user equipment (UE) is configured to generate a first credential based on a second credential, wherein the second credential is used for primary authentication between the UE and a core network, generate an identifier corresponding to the first credential and perform, after the primary authentication, an authentication procedure with an edge configuration server (ECS) for access to an edge data network based on transport layer security (TLS)-pre-shared key (PSK) protocols using the first credential.

### TECHNICAL FIELD

The present disclosure generally relates to communication, and in particular, to an authentication mechanism for access to an edge data network based on TLS-PSK.

### BACKGROUND

A user equipment (UE) may connect to an edge data network to access edge computing services. Edge computing refers to performing computing and data processing at the network where the data is generated. To establish a connection with the edge data network, the UE may have to perform an authentication procedure with an edge data network.

### SUMMARY

Some exemplary embodiments are related to a processor of a user equipment (UE) configured to perform operations. The operations include generating a first credential based on a second credential, wherein the second credential is used for primary authentication between the UE and a core network, generating an identifier corresponding to the first credential and performing, after the primary authentication, an authentication procedure with an edge configuration server (ECS) for access to an edge data network based on transport layer security (TLS)-pre-shared key (PSK) protocols using the first credential.

Other exemplary embodiments are related to an edge configuration server (ECS) configured to perform operations. The operations include receiving a first credential from a network function, wherein the first credential is derived based on second credential used for primary authentication between a user equipment (UE) and a core network and performing an authentication procedure with the UE for access to an edge data network based on transport layer security (TLS)-pre-shared key (PSK) protocols using the first credential.

Still further exemplary embodiments are related to a network function configured to perform operations. The operations comprise generating a first credential based on a second credential, wherein the second credential is used for primary authentication between a user equipment (UE) and a core network, generating an identifier corresponding to the first credential and transmitting the first credential to an edge configuration server (ECS), wherein the first credential is to be used by the ECS during an authentication procedure between the ECS and the UE.

Additional exemplary embodiments are related a user equipment (UE) having a transceiver configured to communicate with a core network and a processor communicatively coupled to the transceiver and configured to perform operations. The operations include generating a first credential based on a second credential, wherein the second credential is used for primary authentication between the UE and the core network, generating an identifier corresponding to the first credential and performing, after the primary authentication, an authentication procedure with an edge configuration server (ECS) for access to an edge data network based on transport layer security (TLS)-pre-shared key (PSK) protocols using the first credential.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an architecture for enabling edge applications according to various exemplary embodiments.

FIG. 4 shows a signaling diagram for an authentication procedure for access to an edge data network according to various exemplary embodiments.

FIG. 5 shows a table for exemplary authentication server function (AUSF) service operations according to various exemplary embodiments.

FIG. 6 shows a signaling diagram for an authentication procedure for access to an edge data network according to various exemplary embodiments.

FIG. 7 shows a signaling diagram for an authentication procedure for access to an edge data network according to various exemplary embodiments.

### DETAILED DESCRIPTION

The exemplary embodiments may be further understood with reference to the following description and the related appended drawings, wherein like elements are provided with the same reference numerals. The exemplary embodiments relate to authentication for access to an edge data network.

The exemplary embodiments are described with regard to a user equipment (UE). However, reference to a UE is merely provided for illustrative purposes. The exemplary embodiments may be utilized with any electronic component that is configured with the hardware, software, and/or firmware to exchange information and data with the network. Therefore, the UE as described herein is used to represent any appropriate electronic component.

The exemplary embodiments are also described with regard to a fifth generation (5G) New Radio (NR) network. However, reference to a 5G NR network is merely provided for illustrative purposes. The exemplary embodiments may be utilized with any network that allows the UE to access an edge data network.

The UE may access the edge data network via the 5G NR network. The edge data network may provide the UE with access to edge computing services. Those skilled in the art will understand that edge computing refers to performing computing and data processing at the network where the data is generated. In contrast to legacy approaches that utilize a centralized architecture, edge computing is a distributed approach where data processing is localized towards the network edge, closer to the end user. This allows performance to be optimized and latency to be minimized.

The exemplary embodiments are described with regard to two different types of authentication procedures, “primary authentication” and “authentication for access to an edge data network.” Throughout this description, primary authentication generally refers to an authentication procedure between the UE and a core network. In the examples provided below, primary authentication procedures may be performed by the UE and an authentication server function (AUSF) of the core network. However, the exemplary embodiments are not limited to this example and may be applicable to a primary authentication procedure performed between the UE and any appropriate type of network function and/or component.

Throughout this description, authentication for access to an edge data network generally refers to an authentication procedure performed by the UE and an edge configuration server (ECS) of an edge data network. However, reference to an ECS is merely provided for illustrative purposes. The exemplary embodiments may be utilized with any electronic component that is configured with the hardware, software, firmware and/or cloud computing functionality to exchange information with the UE. Therefore, the ECS as described herein is used to represent any appropriate electronic component.

The exemplary embodiments introduce an authentication mechanism for access to an edge data network that is based on transport layer security (TLS)-pre-shared key (PSK) protocols. As will be described in more detail below, the exemplary authentication procedure for access to the edge data network may utilize credentials derived based on primary authentication between the UE and the AUSF. In some deployment scenarios, there may be a direct interface between the AUSF and the ECS. In other deployment scenarios, there may not be an interface between the AUSF and the ECS. The exemplary authentication mechanism may be adapted to either of these types of deployment scenarios.

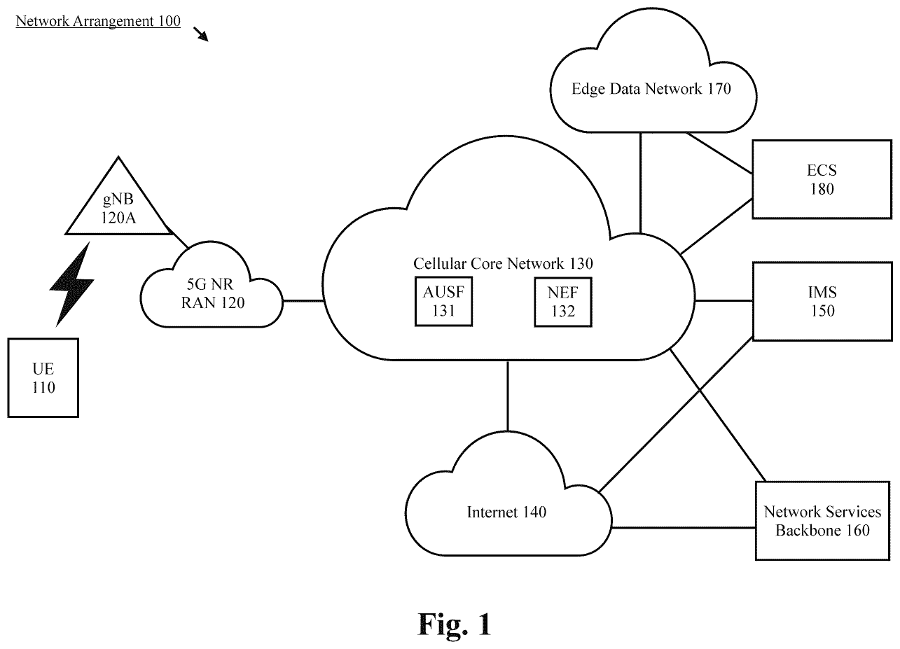

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as indicated above, the 5G NR RAN 120 may be associated with a particular cellular provider where the UE 110 and/or the user thereof has a contract and credential information (e.g., stored on a SIM). Upon detecting the presence of the 5G NR RAN 120, the UE 110 may transmit the corresponding credential information to associate with the 5G NR RAN 120. More specifically, the UE 110 may associate with a specific base station (e.g., gNB 120A).

The network arrangement 100 also includes a cellular core network 130. The cellular core network 130 may be considered as an interconnected set of components or functions that manage the operation and traffic of the cellular network. In this example, the components include an authentication server function (AUSF) 131 and a network exposure function (NEF) 132. However, an actual network arrangement may include various other components performing any of a variety of different functions.

The AUSF 131 may store data for authentication of UEs and handle authentication-related functionality. The AUSF 131 may be equipped with one or more communication interfaces to communicate with other network components (e.g., network functions, RANs, UEs, etc.). The exemplary embodiments are not limited to a AUSF that performs the above referenced operations. Those skilled in the art will understand the variety of different types of operations a AUSF may perform. Further, reference to a single AUSF 131 is merely for illustrative purposes, an actual network arrangement may include any appropriate number of AUSFs.

The NEF 132 is generally responsible for securely exposing the services and capabilities provided by 5G NR-RAN 120 network functions. The NEF 132 may be equipped with one or more communication interfaces to communicate with other network components (e.g., network functions, RANs, UEs, etc.). The exemplary embodiments are not limited to a NEF that performs the above reference operations. Those skilled in the art will understand the variety of different types of operations a NEF may perform. Further, reference to a single NEF 132 is merely for illustrative purposes, an actual network arrangement may include any appropriate number of NEFs.

The network arrangement 100 also includes the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

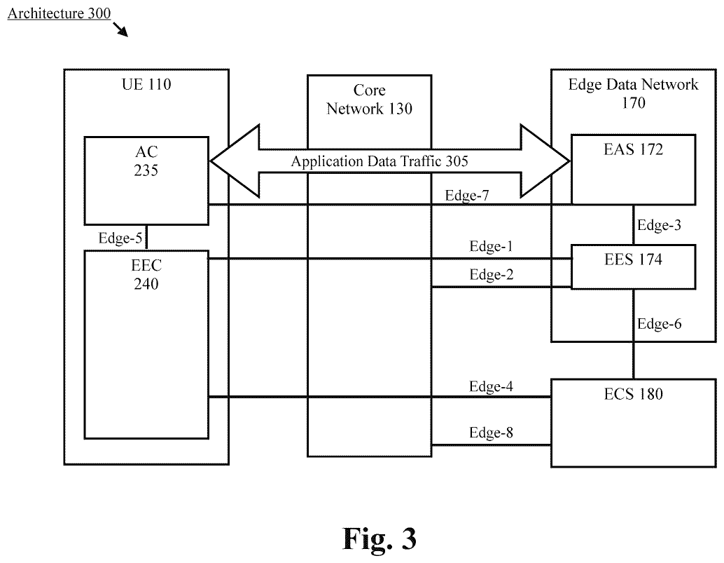

In addition, the network arrangement 100 includes an edge data network 170 and an edge configuration server (ECS) 180. The exemplary embodiments are described with regard to authentication procedures. These authentication procedures may include interactions between the UE 110, the edge data network 170 and the ECS 180. The edge data network 170 and the ECS 180 will be described in more detail below with regard to FIG. 3. Those skilled in the art will understand that an actual network arrangement may include any appropriate number of edge data networks and ECSs. Thus, the example of a single edge data network 170 and single ECS 180 is merely provided for illustrative purposes.

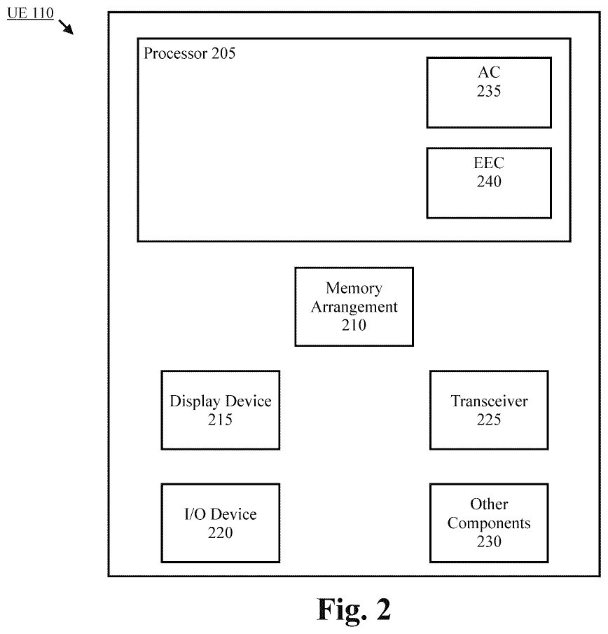

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute various types of software. For example, the processor may execute an application client (AC) 235 and an edge enabler client (EEC) 240. The AC 235 may perform operations related to exchanging application data with a server via a network. The EEC 240 may perform operations in support of the AC 235. For example, the EEC 240 may perform an authentication procedure with an edge data network and other operations related to establishing a connection with the edge data network. Reference to a single AC 235 and EEC 240 is merely provided for illustrative purposes. The UE 110 may be equipped with any appropriate number of application clients supported by an appropriate number of EECs. The AC 235 and the EEC 240 are discussed in more detail below with regard to FIG. 3.

The above referenced software being executed by the processor 205 is only exemplary. The functionality associated with the software may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

FIG. 3 shows an architecture 300 for enabling edge applications according to various exemplary embodiments. The architecture 300 will be described with regard to the network arrangement 100 of FIG. 1 and the UE 110 of FIG. 2.

The exemplary embodiments relate to authentication for access to an edge data network. Successful completion of the authentication procedure may precede the flow of application data traffic 305 between the edge data network 170 and the UE 110. The architecture 300 provides a general example of the type of components that may interact with one another for enabling edge applications. Specific examples of the exemplary authentication procedure will be provided below with regard to the signaling diagrams 400, 600 and 700.

The architecture 300 includes the UE 110, the core network 130 and the edge data network 170. The UE 110 may establish a connection to the edge data network 170 via the core network 130 and various other components (e.g., cell 120A, the 5G NR RAN 120, network functions, etc.).

In the architecture 300, the various components are shown as being connected via reference points labeled edge-x (e.g., edge-1, edge-2, edge-3, edge-4, edge-5, edge-6, edge-7, edge-8, etc.). Those skilled in the art will understand that each of these reference points (e.g., connections, interfaces, etc.) are defined in the 3GPP Specifications. In this description, these reference points may be used in the manner in which they are defined in the 3GPP Specifications and may be modified in accordance with the exemplary embodiments described here. Furthermore, while these interfaces are termed reference points throughout this description, those skilled in the art will understood that these interfaces are not required to be direct wired or wireless connections, e.g., the interfaces may communicate via intervening hardware and/or software components. To provide an example, the UE 110 may exchange signals over the air with the gNB 120A. However, in the architecture 300 the UE 110 is shown as having a direct connection to the edge configuration server (ECS) 180. Those skilled in the art will understand that this connection is not a direct communication link between the UE 110 and the ECS 180. Instead, this is a connection that is facilitated by intervening hardware and software components. Thus, throughout this description the terms “connection,” “reference point” and “interface” may be used interchangeably to describe the interfaces between the various components in the architecture 300 and the network arrangement 100.

During operation, application data traffic 305 may flow between the AC 235 running on the UE 110 and the edge application server (EAS) 172 of the edge data network 170. The EAS 172 may be accessed through the core network 130 via uplink classifiers (CL) and branching points (NP) or in any other appropriate manner. Those skilled in the art will understand the variety of different types of operations and configurations relevant to an application client and an EAS. The operations performed by these components are beyond the scope of the exemplary embodiments. Instead, these components are included in the description of the architecture 300 to demonstrate that the exemplary authentication procedure may precede the flow of application data traffic 305 between the UE 110 and the edge data network 170.

The EEC 240 may be configured to provide supporting functions for the AC 235. For example, the EEC 240 may perform operations related to concepts such as, but not limited to, the discovery of EASs that are available in an edge data network (e.g., EAS 172) and the retrieval and provisioning of configuration information that may enable the exchange of the application data traffic 305 between the AC 235 and the EAS 172. To differentiate the EEC 240 from other EECs, the EEC 240 may be associated with a globally unique value/(e.g., EEC ID) that identifies the EEC 240. Further, reference to a single AC 235 and EEC 240 is merely provided for illustrative purposes, the UE 110 may be equipped with any appropriate number of application clients and EECs.

The edge data network 170 may also include an edge enabler server (EES) 174. The EES 174 may be configured to provide supporting functions to the EAS 172 and the EEC 240 running on the UE 110. For example, the EES 174 may perform operations related to concepts such as, but not limited to, provisioning configuration to enable the exchange of the application data traffic 305 between the UE 110 and the EAS 172 and providing information related to the EAS 172 to the EEC 240 running on the UE 110. Those skilled in the art will understand the variety of different types of operations and configurations relevant to an EES. Further, reference to the edge data network 170 including a single EAS 172 and a single EES 174 is merely provided for illustrative purposes. In an actual deployment scenario, an edge data network may include any appropriate EASs and EESs interacting with any number of UEs.

The ECS 180 may be configured to provide supporting functions for the EEC 240 to connect the EES 174. For example, the ECS 180 may perform operations related to concepts such as, but not limited to, provisioning of edge configuration information to the EEC 240. The edge configuration information may include the information for the EEC 240 to connect to the EES 174 (e.g., service area information, etc.) and the information for establishing a connection with the EES 174 (e.g., uniform resource identifier (URI). Those skilled in the art will understand the variety of different types of operations and configurations relevant to an ECS.

In the network architecture 100 and the enabling architecture 300, the ECS 180 is shown as being outside of the edge data network 170 and the core network 130. In addition, the EAS 172 and the EES 174 are shown as being inside of the edge data network 170. However, these examples are merely provided for illustrative purposes. The EAS 172, the EES 172 and the ECS 180 may be deployed in any appropriate virtual and/or physical location (e.g., within the mobile network operator's domain or within a third party domain) and implemented via any appropriate combination of hardware, software and/or firmware.

The exemplary embodiments are described with regard to two different types of authentication procedures, primary authentication and authentication for access to the edge data network. Primary authentication procedure generally refers to an authentication procedure between the UE 110 and the core network 130. Primary authentication may utilize authentication mechanisms such as 5G authentication key agreement (AKA) and extendible authentication protocol (EAP)-AKA. However, primary authentication is not limited to these mechanisms and the exemplary embodiments may be utilized with any appropriate type of primary authentication mechanism.

During primary authentication, the AUSF 131 may generate a credential K_{AUSF} via authentication vector generation. The K_{AUSF} may then be used for other operations of the primary authentication procedure. Some characteristics of the K_{AUSF} include, i) the K_{AUSF} may be shared between the UE 110 and AUSF 131 and ii) the K_{AUSF} may provide the basis of the subsequent 5G key hierarchy. However, reference to K_{AUSF} is merely provided for illustrative purposes, the exemplary embodiments may apply to any similar type of 3GPP credential or information being used in in addition or instead of K_{AUSF}.

The UE 110 and the AUSF 131 may then each independently generate credentials based on K_{AUSF}. Throughout this description, these credentials may be referred to as “K_{edge}” and “K_{edge} ID.” However, reference to “K_{edge}” and “K_{edge} ID” is merely provided for illustrative purposes, different entities may refer to similar concepts by a different name and any appropriate credentials or parameters may be utilized.

In this example, the credential K_{edge} may be generated using a key derivation function (KDF) and derived from the credential K_{AUSF}. Those skilled in the art will understand that the KDF may be, for example, the KDF defined in Annex B.2.0 of 3GPP Technical Specification (TS) 33.220 or any other similar type of function. The K_{edge}ID parameter may be used to uniquely identify a K_{edge} parameter. The K_{edge}ID parameter may be generated in any appropriate manner. Since the credential K_{AUSF} is shared between the UE 110 and the AUSF 131, the UE 110 and the AUSF 131 may independently generate the same credentials.

Authentication for access to the edge data network may be performed after primary authentication between the UE 110 and the core network 130. In the exemplary embodiments described below, the credentials “K_{edge}” and “K_{edge} ID” may be used in the exemplary authentication procedure for access to the edge data network. However, the examples provided above related to generating these credentials were merely provided for illustrative purposes, the “K_{edge}” and “K_{edge} ID” may be derived in any appropriate manner.

The exemplary embodiments introduce an authentication mechanism for access to an edge data network that is based on TLS-PSK protocols. Some of the examples provided below relate to a deployment scenario where the ECS 180 is within the mobile network operator (MNO) domain. In this type of deployment scenario, there may be a direct interface between the AUSF 131 and the ECS 180. Other examples relate to a deployment scenario where the ECS 180 is outside of the MNO domain. In this type of deployment scenario, there may not be a direct interface between the AUSF 131 and the ECS 180. Instead, the NEF 132 may be used to facilitate the exchange of information between the AUSF 131 and the ECS 180.

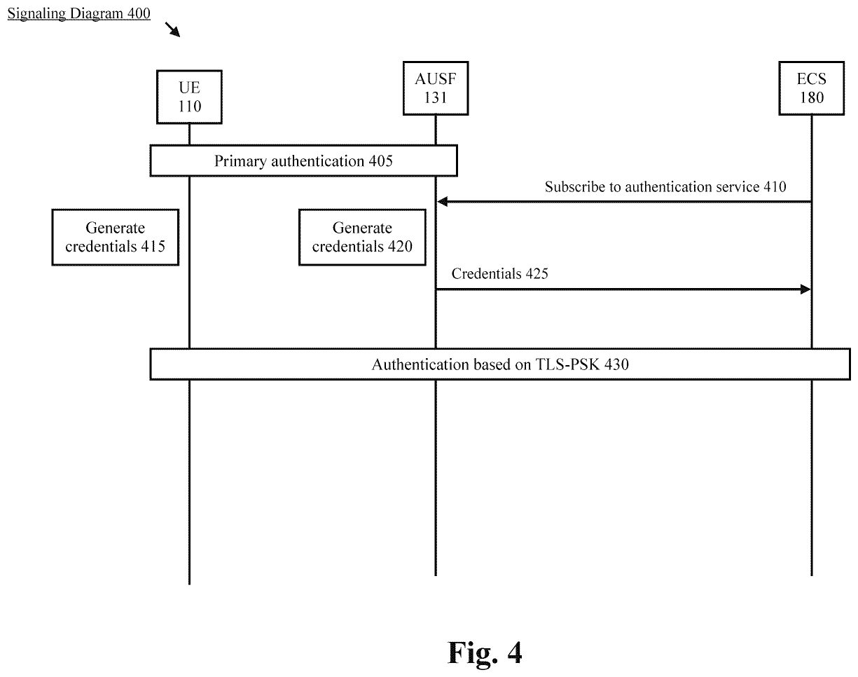

FIG. 4 shows a signaling diagram 400 for an authentication procedure for access to an edge data network according to various exemplary embodiments. The signaling diagram 500 includes the UE 110, the AUSF 131 and the ECS 180. The signaling diagram 400 shows a first exemplary manner of using a credential generated based on a key shared during primary authentication between the UE 110 and the core network 130 for authentication to access the edge data network 170.

In 405, the UE 110 performs primary authentication with the AUSF 131. In accordance with primary authentication, the credential K_{AUSF} may be shared between the UE 110 and the AUSF 131.

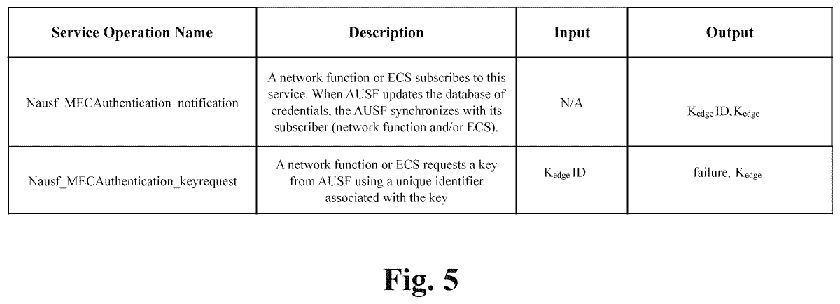

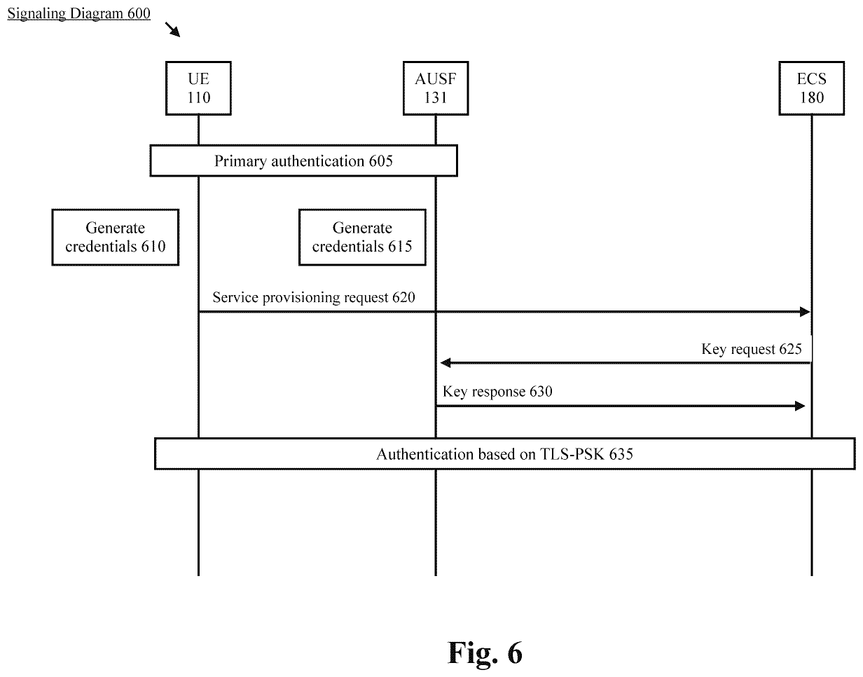

In 410, the ECS 180 subscribes to a authentication service of the AUSF 131. For example, the ECS 180 may send a subscription request to the AUSF 131 for an MEC authentication service. The ECS 180 may subscribe to this service so that when the AUSF 131 updates its credential database (e.g., K_{edge}, K_{edge} ID, etc.), the AUSF 131 is triggered to synchronize with the ECS 180 (and its other subscribers). In this example, this service operation may be named “Nausf_MECAuthentication_notification” where MEC stands for multi-access edge computing. FIG. 5 shows a table 500 for exemplary AUSF service operations. The table 500 includes an entry for the exemplary “Nausf_MECAuthentication_notification” comprising an example description and output parameters. The other entry of the signaling diagram 500 will be described below with regard to the signaling diagram 600 of FIG. 6.

In 415, the UE 110 generates the credentials K_{edge} and K_{edge} ID. For example, the UE 110 may generate these credentials using the credential K_{AUSF} and a subscription permanent identifier (SUPI). However, this example is merely provided for illustrative purposes. As mentioned above, the manner in which the credentials K_{edge} and K_{edge} ID are generated is beyond the scope of the exemplary embodiments. For instance, instead of the SUPI the generic public subscription (GPSI) or any other appropriate parameter may be utilized.

In 420, the AUSF 131 also generates the credentials K_{edge} and K_{edge} ID. In accordance with various standards and regulations, the AUSF 131 may be restricted from storing the credential K_{AUSF}. However, if the MNO supports edge computing (e.g., MEC or any other appropriate architecture), the AUSF 131 may derive the K_{edge} and K_{edge} ID before deleting K_{AUSF}. Thus, the UE 110 and the AUSF 131 may have the same K_{edge} and K_{edge} ID.

In 425, the AUSF 131 sends the credentials K_{edge} and K_{edge} ID to the ECS 180. For instance, the AUSF service operation Nausf_MECAuthentication_notification may trigger the transmission of the credentials K_{edge} and K_{edge} ID over an interface between the AUSF 131 and the ECS 180. This interface may be implemented to enable the AUSF 131 to provide this type of service to the ECS 180.

At this time, the EEC 240 of the UE 110 and the ECS 180 may share the credentials generated based on primary authentication. For example, the EEC 240 of the UE 110 may fetch the credentials K_{edge} and K_{edge} ID from another component of the UE 110. The ECS 180 may have received the credentials associated with the UE 110 based on the authentication service described above.

In 430, the UE 110 and the ECS 180 perform authentication based on TLS-PSK. For example, the EEC 240 of the UE 110 and the ECS 180 may establish a TLS security tunnel based on the pre-shared key K_{edge}. The EEC 240 and the ECS 180 may then complete TLS-PSK in any appropriate manner. For example, the TLS-PSK may be performed in accordance with the standard request for comment (RFC) 8446 where the EEC 240 is the client and the ECS 180 is the server.

Accordingly, a credential generated based on a key shared during primary authentication between the UE 110 and the core network 130 may be used for authentication to access the edge data network 170. The exemplary AUSF service introduced above may enable the core network 130 to provide the ECS 180 with information that enables the UE 110 and the ECS 180 to perform authentication for access to the edge data network based on TLS-PSK.

FIG. 6 shows a signaling diagram 600 for an authentication procedure for access to an edge data network according to various exemplary embodiments. The signaling diagram 600 includes the UE 110, the AUSF 131 and the ECS 180. The signaling diagram 600 shows a second exemplary manner of using a credential generated based on a key shared during primary authentication between the UE 110 and the core network 130 for authentication to access the edge data network 170.

In 605, the UE 110 performs primary authentication with the AUSF 131. In accordance with primary authentication, the credential K_{AUSF} may be shared between the UE 110 and the AUSF 131.

In 610, the UE 110 generates the credentials K_{edge} and K_{edge} ID. For example, the UE 110 may generate these credentials using the credential K_{AUSF} and a SUPI. However, this example is merely provided for illustrative purposes. As mentioned above, the manner in which the credentials K_{edge} and K_{edge} ID are generated is beyond the scope of the exemplary embodiments. For instance, instead of the SUPI the GPSI or any other appropriate parameter may be utilized.

In 615, the AUSF 131 also generates the credentials K_{edge} and K_{edge} ID. In accordance with various standards and regulations, the AUSF 131 may be restricted from storing the credential K_{AUSF}. However, if the MNO supports edge computing (e.g., MEC or any other appropriate architecture), the AUSF 131 may derive the K_{edge} and K_{edge} ID before deleting K_{AUSF}. Thus, the UE 110 and the AUSF 131 may have the same K_{edge} and K_{edge} ID.

In 620, the UE 110 sends a service provisioning request to the ECS 180. For example, the EEC 240 of the UE 110 may fetch the credentials K_{edge} and K_{edge} ID from another component of the UE 110. The EEC 240 may then be triggered to perform a service provisioning procedure with the ECS 180 to receive edge computing information such as but not limited to, identification of the edge data network 170 and information for establishing a connection to the EES 174 (e.g., URI, IP address, etc.). In this example, the service provisioning request may include an EEC ID and the credential K_{edge} ID.

In 625, the ECS 180 sends a key request to the AUSF 131. The key request may include the credential K_{edge} ID. In 630, the AUSF 131 sends the key response to the ECS 180. The key response may include the credentials K_{edge} and K_{edge} ID.

The exemplary embodiments introduce an AUSF service to handle the key request and the key response between the AUSF 131 and the ECS 180. In this example, this service operation may be named “Nausf_MECAuthentication_keyrequest” and configured to handle request from ECSs (and other network function) for K_{edge} based on its related credential K_{edge} ID. The credential may be exchange over an interface between the AUSF 131 and the ECS 180 This interface may be implemented to enable the AUSF 131 to provide this type of service to the ECS 180.

The K_{edge} parameter provided in the key response may then be used for TLS-PSK authentication with the UE 110. FIG. 5 shows a table 500 for exemplary AUSF service operations. The table 500 includes an entry for the exemplary “Nausf_MECAuthentication_keyrequest” comprising an example description, input parameters and output parameters.

At this time, the EEC 240 of the UE 110 and the ECS 180 may share the credentials generated based on primary authentication. For example, the EEC 240 of the UE 110 may fetch the credentials K_{edge} and K_{edge} ID from another component of the UE 110. The ECS 180 may have received the credentials associated with the UE 110 based on the key request service described above.

In 635, the UE 110 and the ECS 180 perform authentication based on TLS-PSK. For example, the EEC 240 of the UE 110 and the ECS 180 may establish a TLS security tunnel based on the pre-shared key K_{edge}. The EEC 240 and the ECS 180 may then complete TLS-PSK in any appropriate manner. For example, the TLS-PSK may be performed in accordance with the standard RFC 8446 where the EEC 240 is the client and the ECS 180 is the server.

Accordingly, a credential generated based on a key shared during primary authentication between the UE 110 and the core network 130 may be used for authentication to access the edge data network 170. The exemplary AUSF service introduced above may enable the core network 130 to provide the ECS 180 with information that enables the UE 110 and the ECS 180 to perform authentication for access to the edge data network based on TLS-PSK.

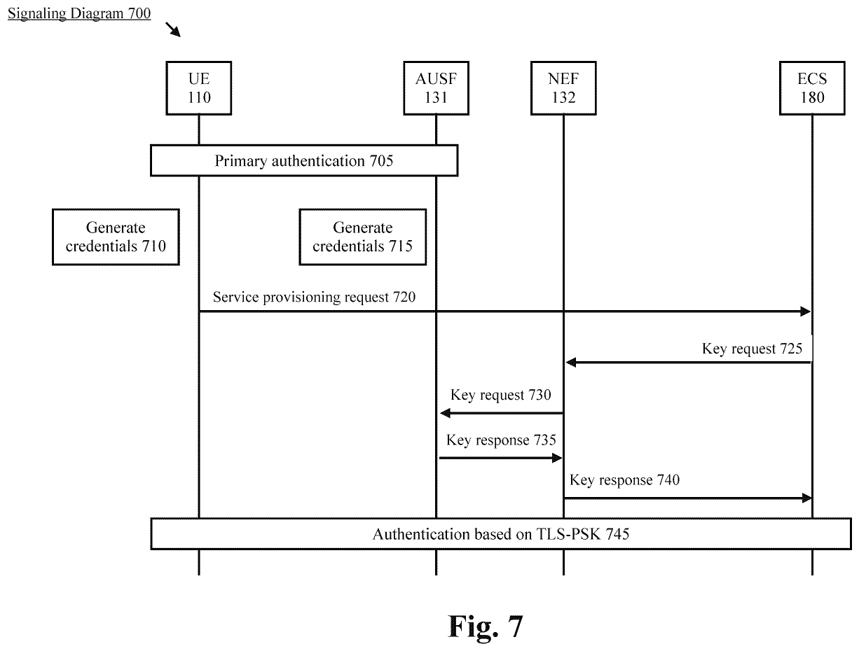

FIG. 7 shows a signaling diagram 700 for an authentication procedure for access to an edge data network according to various exemplary embodiments. The signaling diagram 700 includes the UE 110, the AUSF 131, the NEF 132 and the ECS 180. The signaling diagram 700 shows a third exemplary manner of using a credential generated based on a key shared during primary authentication between the UE 110 and the core network 130 for authentication to access the edge data network 170. In this example, there may not be an interface between the ECS 180 and the AUSF 131. Instead, the NEF 132 may be used to facilitate communication between the AUSF 131 and the NEF 132.

In 705, the UE 110 performs primary authentication with the AUSF 131. In accordance with primary authentication, the credential K_{AUSF} may be shared between the UE 110 and the AUSF 131.

In 710, the UE 110 generates the credentials K_{edge} and K_{edge} ID. For example, the UE 110 may generate these credentials using the credential K_{AUSF} and a SUPI. However, this example is merely provided for illustrative purposes. As mentioned above, the manner in which the credentials K_{edge} and K_{edge} ID are generated is beyond the scope of the exemplary embodiments. For instance, instead of the SUPI the GPSI or any other appropriate parameter may be utilized.

In 715, the AUSF 131 also generates the credentials K_{edge} and K_{edge} ID. In accordance with various standards and regulations, the AUSF 131 may be restricted from storing the credential K_{AUSF}. However, if the MNO supports edge computing (e.g., MEC or any other appropriate architecture), the AUSF 131 may derive the K_{edge} and K_{edge} ID before deleting K_{AUSF}. Thus, the UE 110 and the AUSF 131 may have the same K_{edge} and K_{edge} ID.

In 720, the UE 110 sends a service provisioning request to the ECS 180. For example, the EEC 240 of the UE 110 may fetch the credentials K_{edge} and K_{edge} ID from another component of the UE 110. The EEC 240 may then be triggered to perform a service provisioning procedure with the ECS 180 to receive edge computing information such as but not limited to, identification of the edge data network 170 and information for establishing a connection to the EES 174 (e.g., URI, IP address, etc.). In this example, the service provisioning request may include an EEC ID and the credential K_{edge} ID.

In 725, the ECS 180 sends a key request to the NEF 132. The key request may include the credential K_{edge} ID. In 730, the NEF 132 sends the key request to the AUSF 131. In this example, the AUSF service operation “Nausf_MECAuthentication_keyrequest” may be configured to handle requests from the NEF 132 and provide a response to the NEF 132. In 735, the AUSF 131 sends a key response to the NEF 132. The key response may include the credentials K_{edge} and K_{edge} ID. In this example, it is assumed that the AUSF 131 finds the credential information based on K_{edge} ID. However, there may be scenarios where the AUSF 131 is unable to find credential information associated with the K_{edge} ID. In this type of scenario, the AUSF 131 may send a failure message indicating that the credential information cannot be found.

In 740, the NEF 132 sends the key response to the ECS 180. The interface between the NEF 132 and the ECS 180 may be configured for encrypted communications. Thus, in some examples, the NEF 132 may encrypt the key response prior to forwarding the key response and the ECS 180 may unencrypt the contents of the key response.

In other embodiments, instead of the key request and response mechanism, the NEF 131 may utilize the authentication service described above with regard to the method 400. Thus, the NEF 132 may subscribe to the AUSF 131 and receive the credential information when it is updated at the AUSF 131. The NEF 132 may then provide the credentials to the ECS 180 in response to a request from the ECS 180, in response to the reception of the credentials from the AUSF 131 or based on any other appropriate condition.

At this time, the EEC 240 of the UE 110 and the ECS 180 may share the credentials generated based on primary authentication. For example, the EEC 240 of the UE 110 may fetch the credentials K_{edge} and K_{edge} ID from another component of the UE 110. The ECS 180 may have received the credentials associated with the UE 110 based on the key response from the NEF 132.

In 745, the UE 110 and the ECS 180 perform authentication based on TLS-PSK. For example, the EEC 240 of the UE 110 and the ECS 180 may establish a TLS security tunnel based on the pre-shared key K_{edge}. The EEC 240 and the ECS 180 may then complete TLS-PSK in any appropriate manner. For example, the TLS-PSK may be performed in accordance with the standard RFC 8446 where the EEC 240 is the client and the ECS 180 is the server. Accordingly, a credential generated based on a key shared during primary authentication between the UE 110 and the core network 130 may be used for authentication to access the edge data network 170.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
generate a first credential based on a second credential, wherein the second credential is used for primary authentication between the UE and a core network;
generate an identifier corresponding to the first credential; and
perform, after the primary authentication, an authentication procedure with an edge configuration server (ECS) for access to an edge data network based on transport layer security (TLS)-pre-shared key (PSK) protocols using the first credential.

2. The apparatus of claim 1, wherein performing the authentication procedure comprises establishing a TLS security tunnel with the ECS based on a pre-shared key, wherein the pre-shared key comprises the first credential.

3. The apparatus of claim 1, wherein the core network comprises an authentication server function (AUSF) configured to perform the primary authentication with the UE and the second credential comprises K_{AUSF}.

4. The apparatus of claim 1, wherein the first credential comprises K_{edge} and the identifier comprises K_{edge} ID.

5. The apparatus of claim 1, wherein the core network derives the first credential independently from the UE and provides the first credential to the ECS.

6. An edge configuration server (ECS) configured to:
receive a first credential from a network function, wherein the first credential is derived based on second credential used for primary authentication between a user equipment (UE) and a core network; and
perform an authentication procedure with the UE for access to an edge data network based on transport layer security (TLS)-pre-shared key (PSK) protocols using the first credential.

7. The ECS of claim 6, wherein performing the authentication procedure comprises establishing a TLS security tunnel with the UE based on a pre-shared key, wherein the pre-shared key comprises the first credential.

8. The ECS of claim 6, wherein the network function is an authentication server function (AUSF) configured to perform the primary authentication with the UE and the second credential comprises K_{AUSF}.

9. The ECS of claim 6, wherein the first credential comprises K_{edge}.

10. The ECS of claim 6, further configured to:
subscribe to an authentication server function (AUSF) service operation, wherein the network function is an AUSF and the AUSF service operation is configured to provide the first credential and the identifier to the ECS.

11. The ECS of claim 6, further configured to:
receive a service provisioning request from the UE, wherein the service provisioning request comprises an identifier corresponding to the first credential;
transmit a key request to the network function, wherein the key request comprises the identifier corresponding to the first credential; and
receive a key response from the network function, wherein the key response comprises the first credential.

12. The ECS of claim 11, wherein the network function independently derives the first credential and the identifier corresponding to the first credential based on the second credential.

13. The ECS of claim 6, further configured to:
receive a service provisioning request from the UE, wherein the service provisioning request comprises an identifier corresponding to the first credential;
transmit a key request to the network function, wherein the network function is a network exposure function (NEF) configured to forward the key request to an authentication server function (AUSF); and
receive a key response from the network function, wherein the key response comprises the first credential.

14. A network function configured to:
generate a first credential based on a second credential, wherein the second credential is used for primary authentication between a user equipment (UE) and a core network;
generate an identifier corresponding to the first credential; and
send the first credential to an edge configuration server (ECS), wherein the first credential is to be used by the ECS during an authentication procedure between the ECS and the UE.

15. The network function of claim 14, wherein the network function is an authentication server function (AUSF) configured to perform the primary authentication with the UE and the second credential comprises K_{AUSF}.

16. The network function of claim 14, wherein the first credential comprises K_{edge} and the identifier comprises K_{edge} ID.

17. The network function of claim 14, further configured to:
receive a subscription request from the ECS for an authentication server function (AUSF) service operation, wherein the AUSF service operation is configured to provide the first credential and the identifier to the ECS.

18. The network function of claim 14, further configured to:
receive a key request from the ECS, wherein the key request comprises the identifier corresponding to the first credential; and
send a key response to the ECS, wherein the key response comprises the first credential.

19. The network function of claim 14, further configured to:
receive a key request from a network exposure function (NEF), wherein the NEF configured to forward the key request to the network function for the ECS; and
send a key response to the NEF, wherein the key response comprises the first credential and the NEF forwards the key response to the ECS.

20-24. (canceled)
